(19) United States
(12) Patent Application Publication
(10) Pub. No.: US 2024/0326315 A1
(43) Pub. Date: Oct. 3, 2024

(54) Avoidance of Scratches on the Film

(71) Applicant: Windmöller & Hölscher KG, Lengerich (DE)

(72) Inventor: Tim Kirchhoff, Lengerich (DE)

(21) Appl. No.: 18/580,837

(22) PCT Filed: Jul. 21, 2022
(86) PCT No.: PCT/EP2022/070484

§ 371 Date: Jan. 22, 2024

(30) Foreign Application Priority Data
Jul. 22, 2021 (DE) 10 2021 207 875.3

(51) Int. Cl. B29C 55/06; B65H 20/12; B65H 23/188

(52) U.S. Cl. CPC B29C 55/06; B65H 20/12; B65H 23/188; B29K 2995/0087; B65H 2301/5124; B65H 2406/33; B65H 2701/1752

(57) ABSTRACT

The inventions describes a roller for guiding a film web and for subjecting the film web to an at least partially radially inwardly directed force, wherein openings are provided in the surface for applying the inwardly directed force, wherein the openings can be subjected at least partially to a negative pressure from a negative pressure source.

For this purpose, at least one device for increasing the radially inwardly directed force and/or the roller are/is configured such that the film web is movable relative to the roller surface without damage being brought about on the film web.

The invention relates to a roller for guiding a film web and for subjecting the film web to an at least partially radially inwardly directed force.

It is the task of such rotating rollers to guide a moving film web, in particular, a film web made of plastic material or at least comprising plastic material, and while doing so, hold it firmly on its peripheral surface. For the purpose of holding, it is provided that the roller comprises openings on it peripheral surface, which openings are subjected to a negative pressure provided from a negative pressure source. This causes the film web to be suctioned to the peripheral surface. However, with known rollers it cannot always be avoided that local small relative movements of parts of the film web relative to the roller occur in the direction of the peripheral surface of the roller. This applies, in particular, to the leading edge, where the film web comes into contact with the roller, and/or to the separation edge, where the film web leaves the roller again. Even a minimal movement, i.e., in particular, a movement of less than 1 mm can cause damage to the film web. Damage is possible even without movement of the film web relative to the roller peripheral surface, since the film can assume a different position in the radial direction at the openings than on the surfaces outside the openings. Overall, the damage may manifest itself as scratches, but also as local tensions within the film web at these locations, which, for example, may result in a different transparency or other different properties of the film web.

The object of the present invention is therefore to propose a roller and a method with which the damages to the film web can be minimized.

According to the invention, this object is achieved by all of the features of claim 1.

According to the invention, at least one device for increasing the radially inwardly directed force and/or the roller are/is configured such that the film web is movable relative to the roller surface without damage being brought about on the film web. The movement of the film web is, in particular, minimal, i.e., less than 1 mm.

In the first case, the tendency of the film web to move relative to the peripheral surface of the roller is further reduced. This is done by applying another force which further increases the total radially inwardly directed force acting on the film. Alternatively or additionally, the roller is designed to avoid damage.

In the latter case, the roller is, in particular, surface-treated, coated or refined in some other way to avoid damage as far as possible if there is a local movement of the film web relative to the peripheral surface after-all.

To increase the radially inwardly directed force, one aspect of the invention provides that the introduction of air, which the film web entrains along its boundary layers, is avoided. The introduced air gets between the film web and the peripheral surface of the roller, which means that the radially inwardly directed force is reduced. It is intended to position a suction device directly at the leading edge between the film web and the roller with which the introduced air can be sucked out. The suction device comprises a suction nozzle which is directed toward the leading edge. The suction nozzle is arranged on a suction body which can be subjected to a negative pressure. The suction nozzle is designed as a strip extending parallel to the longitudinal axis of the roller. Alternatively or additionally, the roller may be arranged within a closed cavity, which only comprises slot-shaped openings for the inlet and outlet of the film web. Said cavity can also be subjected to a negative pressure to minimize the air entrained by the film web.

To be able to remove the introduced air, the peripheral surface may be provided with depressions into which the air can enter. As a result, less air remains in the surface areas outside of these depressions, so that the film web adheres better to these surface areas. Such depressions may be designed as so-called Nano cross grooves, the widths and/or depths of which are in the nanometer range, i.e., less than 1 mm.

It is also advantageous if the forces acting on the film through the openings in the roller are increased. For this purpose, sealing elements are provided which seal the roller in the areas of the peripheral surface that remain uncovered by the film web. These are first of all the side areas of the roller that extend beyond the width of the film web and in which there are also openings. In addition, said areas are also the areas that are outside the wrap angle of the film web. Said sealing elements accomplish that no so-called false air, i.e., air directly from the surroundings, is sucked in.

Furthermore, it is advantageous to bring the temperature of the roller and/or the immediate surroundings of the roller above the temperature of the film. This allows the film to be softened slightly so that the static friction is increased, which means it “sticks” better to the roller. The air temperature in the immediate surroundings can continue to be higher than the air temperature in the wider area to minimize the ambient air pressure near the roller.

The force acting on the film in the radial direction can be further increased by electrically charging the film or at least electrically polarizing it. For this purpose, at least one electrode is provided, which is arranged in the area of the wrap angle of the film web around the roller and/or upstream thereof. With such an electrode, the film web can be subjected to an electrical voltage. In particular, it is provided that the electrode is arranged in the area of the leading edge, so that the film web is already electrically charged or polarized at this edge.

To increase the static friction between the roller and the film web, the roller may be provided with a coating. An adhesive coating is particularly advantageous, wherein the molecules of the film web and the molecules of the coating interact, wherein said interaction is an attracting interaction.

It is also advantageous if the diameter is selected to be small, with “small” meaning, in particular, a diameter that is a maximum of 10% of the length of the roller. In this case, the roller has a small weight, which reduces deflection of the roller. A deflection would mean that additional air from the film web can be introduced into the space resulting from the deflection, which reduces the radially inwardly directed force. To further reduce the deflection, another roller may be provided which presses against the roller from below (relative to the normal direction of gravity).

A further, advantageous embodiment of the invention comprises at least one element for mechanically pressing the film against the roller. In particular, at least one pressure roller is provided, which may be arranged in the area of the leading edge, but also in the area of the separation edge. It is advantageous if the pressure roller only acts on the edge area of the film web. The edge area of the film web is often separated during subsequent processing of the film web, so that pressing the film web against the roller, or even pressing it firmly, has no adverse effects. Pressing the edge areas of the film web against the roller, results in the areas lying between the edges of the film web also being held in place. Of course, a pressure roller may also extend across the entire width of the film. However, it is also advantageous to provide at least one pressure band touching the film web not only in a line, but in a partial area of the wrap angle of the film web around the roller. In the transverse direction of the film web, the pressure band may in turn extend across the entire width of the film web or only act on the edge areas of the film web. A pressure band preferably comprises a metal band, which can provide large pressing forces.

In a further aspect of the invention, a device for subsequently reducing damage to the film web may be provided. In such a device, a heating element may be provided downstream of the roller, with which the film web can be brought to its melting temperature or a higher temperature. It is advantageous if the heating element is located inside a closed box to heat the surroundings as little as possible and to heat the advancing film only for a limited period of time. Preferably, the box and/or the transport speed are/is designed so that this period is less than 3 seconds, which leads to so-called “ultra-short heating”, so that only the surfaces of the film are significantly heated.

In a further aspect of the invention it is provided to design the roller so that movement of parts of the film web is possible. In doing to, damage must be avoided.

In an advantageous embodiment of the invention, the roller is coated, wherein the coating is chrome plating or a plastic coating. A polymer coating, for example comprising a polytetrafluoroethene, is also conceivable. An alternative or additional coating may comprise amorphous plastic, often referred to as diamond-like carbon (DLC).

To apply a coating, for example, laser pulse deposition of thin layers (PLD process) can be used, in which a material vaporized with a laser is deposited onto the roller surface. By choosing the material and influencing it before or during deposition, a particularly smooth and solid surface can be created on the roller. Other methods for vaporizing the material may also be used, such as bombarding the still solid material with jets of matter (e.g., with ions or electrons) or arc discharge can be provided.

To further compact the coating during the coating process, a pressing element may be provided, with which the coating is further compacted.

However, a coating may also comprise a lacquer coating, for example with a textured lacquer.

The aforementioned coatings each serve to provide a very smooth surface of the roller, wherein the film web is not damaged even during movement.

A coating may also comprise nanoparticles which are arranged on the film web as types of nubs. Although minor damage to the film web may occur, due to the size of the nanoparticles, these are not visible and do not affect further processing of the film web.

It is also advantageous to provide a surface-treated roller as an alternative or in addition to providing a coating. This is understood to mean processing the peripheral surface or surface of the roller with a method that removes and/or locally displaces material. One method is a pressing method in which high pressure is exerted on the roller surface with a pressing element, whereby the surface of the roller is smoothed. Surface treatment methods also include mechanical brushing or blasting the surface with a blasting material, such as sand or glass beads. Blasting can be abrasive or non-abrasive. Electrochemical or electrolytic polishing is also advantageous and can be used, in particular, to reduce roughness in the micro range. Ablation using laser pulses can serve the same purpose.

Instead of a solid coating, a coating on a roller may be provided, wherein a relative movement occurs within the coating. This means that the interface of the coating adjacent to the surface of the roller does not move relative to said surface and that the interface of the coating adjacent to the surface of the film web likewise does not move relative to that surface. For example, a resilient coating may be provided, such as rubber. Of course, this coating is permeable to air to allow the negative pressure passed through the openings to pass through. For example, a rubber provided is preferably a porous or a microporous rubber. For this purpose, a rubber, as well as a different other resilient coating, can be perforated or micro-perforated. A resilient coating may also comprise a plastic film.

A coating that also has a resilient effect may comprise a net-like structure, with the individual threads having a tendency to curl. Here, local areas of the coating can roll on the surface of the roller or on the surface of the film web and thus enable a low-damage movement of the film web relative to the roller. Such a coating could, for example, comprise a structure such as a nylon stocking.

Another coating having the effect described above is flocking the roller, whereby each individual flake allows a relative movement between the roller and the film web.

A further, advantageous embodiment for avoiding damage to the film web comprises treating the film web and/or the roller during operation. A lubricant may be used to enable the film web to move relative to the roller. For this purpose, a lubricant dispenser may be provided upstream of the leading edge, with which a lubricant is continuously applied to the roller and/or the film web, which lubricant gets between the roller and the film web. Such a lubricant then forms, in particular, a continuous lubricating film. Water, particularly in the form of mist, is preferably provided as the lubricant. It is advantageous if the water is distilled.

Treatment of the film web may also comprise the addition of agents during film production. For example, a slip agent or lubricant, or an anti-blocking agent may be added to a film.

A further, advantageous development comprises a cooling device with which the film web can be cooled, in particular cooled abruptly. This cooling device is preferably arranged upstream and, in particular, immediately in front of the leading edge. The rapid cooling allows the film web to solidify further, so that its tendency to move relative to the roller decreases.

It is also advantageous if a movement of the film web relative to the roller can be actively supported. In this case, the film web can be lifted off the roller, in particular, in the area of the separation edge to avoid a local relative movement of the film web along the roller surface. It may thus be provided that the openings of the roller can be selectively acted upon with negative pressure or with positive pressure. Furthermore, a pressure roller may also be arranged at the separation edge, with which it is ensured that the separation edge is formed as a separation line, i.e., runs essentially transversely to the transport direction of the film web. It is also advantageous if a mechanical detachment element, for example a scraper blade, is provided, with which uniform detachment is ensured.

A roller as described may advantageously be combined with a stretching device for stretching a plastic film in its transport direction. The stretching device comprises a first roller over which the plastic film can be guided and which can be driven with a first drive and rotated at a first circumferential speed, and a second roller over which the plastic film can be guided and which can be driven with a second drive and which can be rotated at the second circumferential speed, wherein the second circumferential speed is greater than the first circumferential speed, wherein the second roller is arranged downstream of the first roller in the transport path of the plastic film, so that the plastic film can be stretched in the free area between the first and the second roller. The first roller may be designed according to one or more embodiments of the rollers according to the invention described above. The second roller may also be designed according to one or more embodiments of the rollers according to the invention described above.

In particular with such stretching devices, the phenomenon occurs that the width of the film web is reduced between these two rollers (so-called neck-in), with the edges thickening at the same time. The thickening, in particular, means that the edges of the film web have to be trimmed for further processing. These effects do not start or end only after the film web has left the roller respective or before it has run onto it, but rather already while the film web is still on the roller or is already resting on the roller. This causes the aforementioned damage to the film web to occur.

The above object is further achieved by a method for guiding a film web and for applying an at least partially radially inwardly directed first force to the film web, wherein the first force is applied by means of openings in the surface which are at least partially subjected to a negative pressure originating from a negative pressure source, wherein the radially inwardly directed force is increased using at least one device for increasing and/or the roller is designed such that the film web is moved relative to the roller surface without causing damage to the film web. This method achieves the same advantages as have already been described in connection with the roller according to the invention.

Further advantages, features and details of the invention are shown in the following description, in which various exemplary embodiments are explained in detail with reference to the figures. The features mentioned in the claims and in the description can each be essential to the invention individually or in any combination of features mentioned. Within the scope of the entire disclosure, features and details that are described in connection with the method according to the invention naturally also apply in connection with the roller according to the invention and vice versa, so that reference is or can always be made reciprocally to the individual aspects of the invention with regard to the disclosure. The individual figures show:

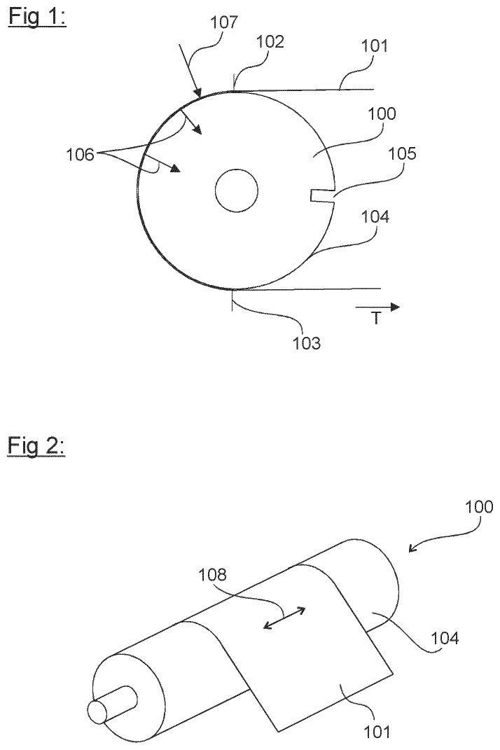

FIG. 1 a side view of a roller according to the invention;

FIG. 2 a schematic perspective view of a roller according to the invention.

FIG. 1 shows a roller 100 according to the invention, over which a film web 101 runs, wherein the film web is in contact with the roller 100 between the leading edge 102 and the separating edge 103 over a wrap angle. The film web is transported in the direction of the transport path T. To avoid moving the film web 101 in or against the transport direction T, the roller comprises numerous openings 105 distributed across its peripheral surface 104, one of which is shown. Said openings 105 can be subjected to a negative pressure, so that the film web is pulled onto the peripheral surface 104 in the area of the wrap angle. The resulting force that acts on the film web 101 in the area of the wrap angle is shown by the arrows 106. This force is essentially directed radially to the roller axis. According to the invention, further means are now provided with which a second force can be provided which acts on the film web in the radial direction. Thus, the first force, represented by the arrows 106, is increased by a second force, represented by the arrows 107.

FIG. 2 shows the same roller as FIG. 1, but in a perspective view. This view shows that the film web or at least areas thereof are movable relative to the peripheral surface 104 of the roller 100.

### REFERENCE SIGN LIST

100 Roller
101 Film web
102 Leading edge
103 Separating edge
104 Peripheral surface
105 Openings
106 Arrow for illustrating the force acting in the wrap angle
107 Arrow for illustrating the second force acting on the film web in the radial direction
T Transport path

1. A roller for guiding a film web and for subjecting the film web to an at least partially radially inwardly directed force, wherein openings are provided in the surface for applying the inwardly directed force, wherein the openings are at least partially subjectable to a negative pressure from a negative pressure source, wherein at least one device for increasing the radially inwardly directed force and/or the roller are/is configured such that the film web is movable relative to the roller surface without damage being brought about on the film web.

2. A stretching device for stretching a plastic film in its transport direction, comprising a first roller over which the plastic film is guidable and which is drivable with a first drive and rotatable at a first circumferential speed, and comprising a second roller over which the plastic film is guidable and which is drivable with a second drive and rotatable at a second circumferential speed, wherein the second circumferential speed is greater than the first circumferential speed, wherein the second roller is arranged downstream of the first roller in the transport path of the plastic film, so that the plastic film is stretchable in the free area between the first and the second roller, wherein the first and/or the second roller are designed according to claim 1.

3. A method for guiding a film web and for subjecting the film web to an at least partially radially inwardly directed force, wherein the first force is applied by means of openings in the surface, which are at least partially subjected to a negative pressure originating from a negative pressure source, wherein the radially inwardly directed force is increased with at least one device for increasing and/or the roller is designed such that the film web is moved relative to the roller surface without causing damage to the film web.
